(19) United States
(12) Patent Application Publication
(10) Pub. No.: US 2005/0185273 A1
(43) Pub. Date: Aug. 25, 2005

(54) Projector screen assembly

(76) Inventor: Pao Chen Lee, Yung Kang City (TW)

Correspondence Address: CHARLES E. BAXLEY, ESQ., 90 JOHN STREET, THIRD FLOOR, NEW YORK, NY, 10038, US

(21) Appl. No.: 10/787,774

(22) Filed: Feb. 24, 2004

(51) Int. Cl. G03B 21/26; G03B 21/56

(52) U.S. Cl. 359/461

(57) ABSTRACT

A projector screen assembly includes a housing, a screen, and a display mounted to the housing for displaying time, temperature, humidity, date, etc. Thus, a person may know the information of time, temperature, humidity, date, etc. without the need to bow his or her head while he or she is watching the content projected on the screen.

### BACKGROUND OF THE INVENTION

1. Field of the Invention

The present invention relates to a projector screen assembly. In particular, the present invention relates to a projector screen assembly that can display time, temperature, humidity, etc.

2. Description of the Related Art

A projector screen assembly is widely used in conference rooms, teaching rooms, etc. FIG. 5 of the drawings illustrates a conventional projector screen assembly comprising a housing 1′ and a screen 12′ that can be coiled in the housing 1′ when not in use. Each end of the housing 1′ is closed by an end cap 11′. A problem for a person watching the screen is that he or she would miss the content projected on the screen if he or she bows his or her head to see the time.

The present invention is intended to provide an improved projector screen assembly to solve this problem.

### SUMMARY OF THE INVENTION

In accordance with an aspect of the present invention, a projector screen assembly includes a housing, a screen, and a display means mounted to the housing for displaying time, temperature, humidity, date, etc. Thus, a person may know the information of time, temperature, humidity, date, etc. without the need to bow his or her head while he or she is watching the content projected on the screen.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view, partly exploded, of a projector screen assembly in accordance with the present invention.

FIG. 2 is a sectional view of a portion of the projector screen assembly in accordance with the present invention.

FIG. 3 is a perspective view of the projector screen assembly in accordance with the present invention, wherein a display of the projector screen assembly is displaying time.

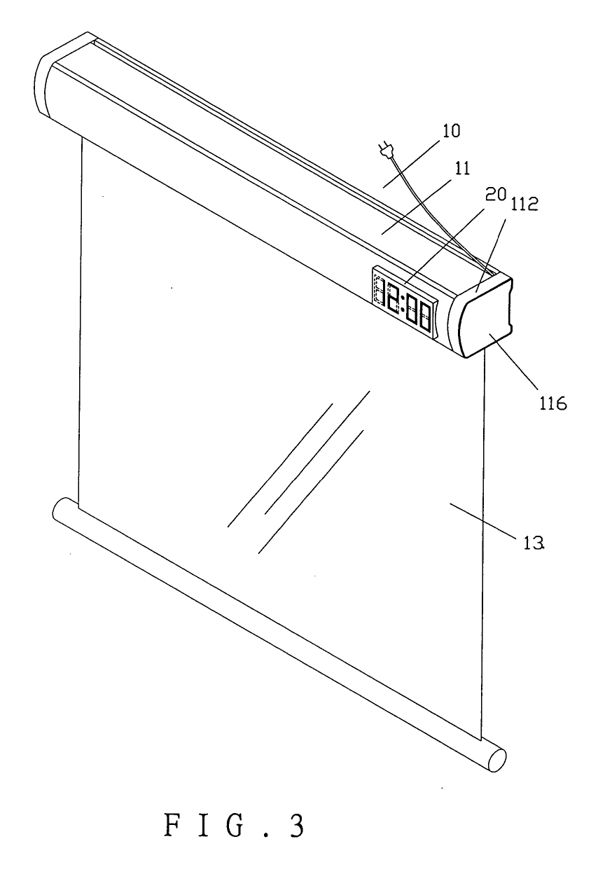

FIG. 4 is a perspective view of the projector screen assembly in accordance with the present invention, wherein the display of the projector screen assembly is displaying temperature.

FIG. 5 is a perspective view, partly exploded, of a conventional projector screen assembly.

### DETAILED DESCRIPTION OF THE PREFERRED EMBODIMENT

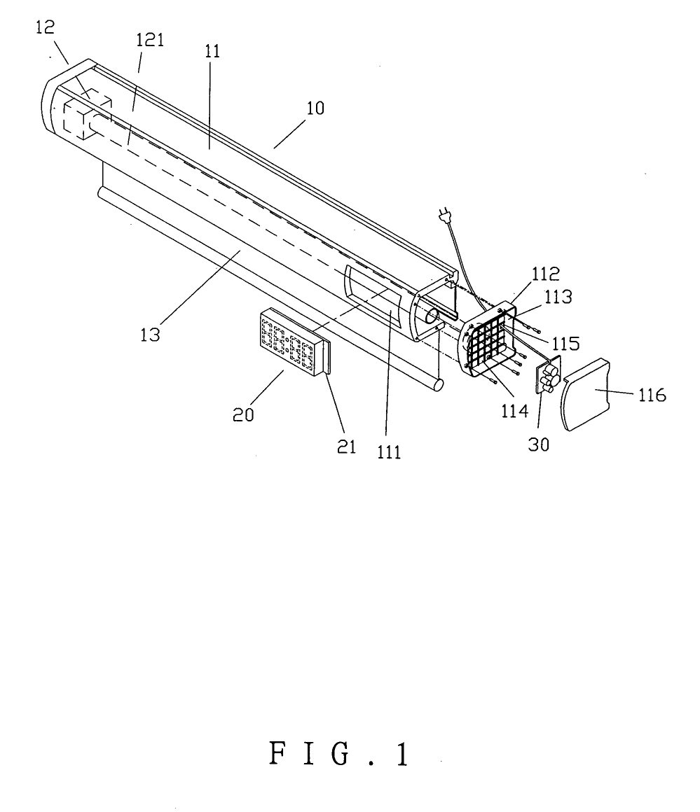

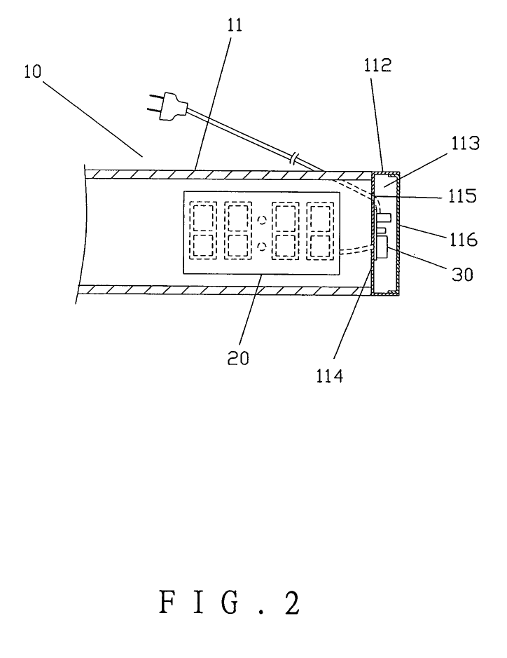

Referring to FIGS. 1 and 2, a projector screen assembly 10 in accordance with the present invention comprises a housing 11, a screen 13, a motor 12, and a display means 20. The housing 11 includes a coupling portion 111 to which the display means 20 is mounted. In this embodiment, the coupling portion 111 is an opening for fittingly receiving the display means 20. An engaging seat 112 is mounted to an open end of the housing 11 and defines a compartment 113 for receiving a power circuit board 30. The power circuit board 30 is electrically connected to an alternating current power source, and a transformer (not shown) is provided for outputting low-voltage alternating current. A partitioning plate 114 can be provided to isolate the compartment 113 from an interior of the housing 11. The partitioning plate 114 includes a through-hole 115 through which wires (not labeled) extends. An end cap 116 is provided to cover the open end of the housing 11 to which the coupling seat 112 is mounted. The motor 12 can be activated to move the screen 13 to a fully or at least partially unfolded position or a retracted position in the housing 11 in which the screen 13 is coiled about a shaft 121 rotatably driven by the motor 12.

The display means 20 may display time, temperature, humidity, etc. The display means 20 includes a circuit board 21 on which a sensor (not shown) for detecting temperature or humidity is mounted. Further, a plurality of liquid crystal displays (LCD) can be mounted on the circuit board 21 for alternately and repeatedly displaying time, temperature, and humidity at an interval of, e.g., 30 seconds.

Since the high-voltage alternating current power source is connected to the power source circuit board 30 mounted in the engaging seat 112, which, in turn, is insulated by the partitioning plate 114, safety is guaranteed. Further, the partitioning plate 114 prevents the heat generated by the transformer from entering the interior the housing 11. Thus, the compartment 113 of the engaging seat 112 not only provides a space for mounting the power source circuit board 30 but also provides a buffering space for safety purposes.

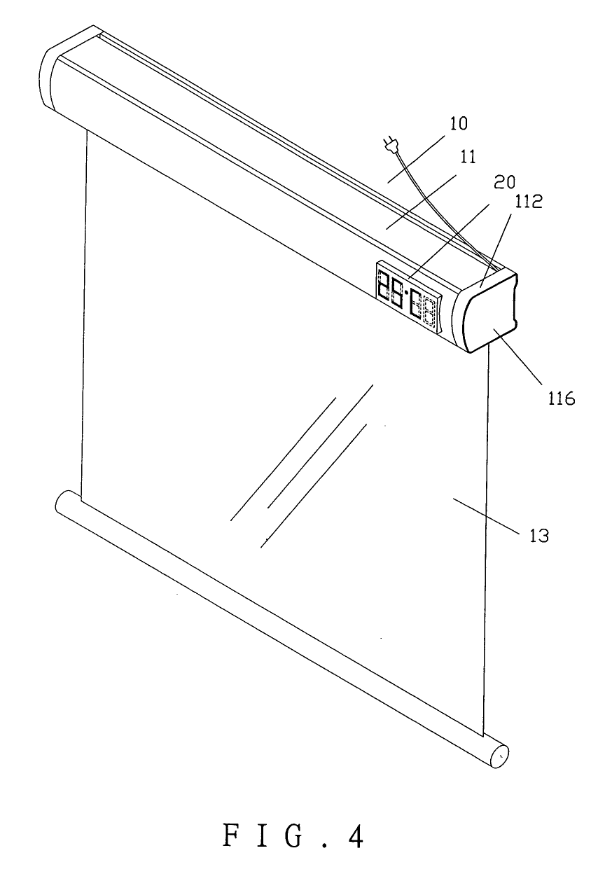

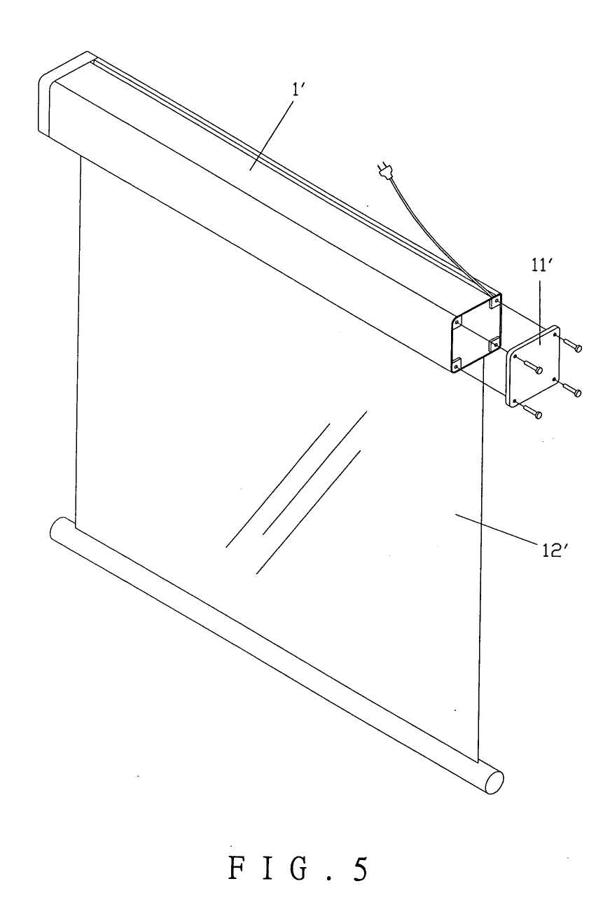

The display means 20 can be directly viewed by the person in front of the screen 13, with the display means 20 alternately and repeatedly displaying time (see FIG. 4), temperature (FIG. 5), and humidity. Thus, the person looking at the screen 13 may know the time, temperature, and humidity without the need to bow his or her head.

It is noted that the display means 20 may display other information, such as date. Further, the power source can be a battery unit.

Although the invention has been explained in relation to its preferred embodiment, it is to be understood that many other possible modifications and variations can be made without departing from the scope of the invention as hereinafter claimed.

1. A projector screen assembly comprising:
a housing;
a screen; and
a display means mounted to the housing, the displaying means displaying information.

2. The projector screen assembly as claimed in claim 1, wherein the housing includes a coupling portion to which the display means is mounted.

3. The projector screen assembly as claimed in claim 2, wherein the coupling portion is an opening for fittingly receiving the display means.

4. The projector screen assembly as claimed in claim 1, wherein the housing includes an open end, further including an engaging seat mounted to the open end of the housing and defining a compartment for receiving a power circuit board that is electrically connected to an alternating current power source and that outputs low-voltage direct current.

5. The projector screen assembly as claimed in claim 4, further including a partitioning plate for isolating the compartment from an interior of the housing.

6. The projector screen assembly as claimed in claim 5, wherein the partitioning plate includes a through-hole through which wires extends.

7. The projector screen assembly as claimed in claim 4, further including an end cap for closing an end of the housing.

8. The projector screen assembly as claimed in claim 1, wherein the information displayed by the displaying means includes at least one of time, temperature, date, and humidity.

9. The projector screen assembly as claimed in claim 8, wherein at least two of the time, the temperature, the date, and the humidity are repeatedly and alternately displayed.
